(19) United States
(12) Patent Application Publication
(10) Pub. No.: US 2020/0410870 A1
(43) Pub. Date: Dec. 31, 2020

(54) METHOD AND DEVICE FOR NIGHT FLIGHT MANAGEMENT OF UNMANNED AERIAL VEHICLE

(71) Applicant: SZ DJI TECHNOLOGY CO., LTD., Shenzhen (CN)

(72) Inventors: Guofang ZHANG, Shenzhen (CN); Yun YU, Shenzhen (CN); Renli SHI, Shenzhen (CN)

(21) Appl. No.: 17/013,721

(22) Filed: Sep. 7, 2020

Related U.S. Application Data
(63) Continuation of application No. PCT/CN2018/078257, filed on Mar. 7, 2018.

(51) Int. Cl. G08G 5/00; B64C 39/02

(52) U.S. Cl. CPC G08G 5/003; G08G 5/0095; G08G 5/0013; B64C 2201/146; G08G 5/0069; B64C 39/024; B64C 2201/145; G08G 5/0026

(57) ABSTRACT

A night flight management method for an unmanned aerial vehicle (UAV) includes determining whether the UAV is in night flight or is about to enter night flight, and performing a flight control operation in response to determining that the UAV is in night flight or is about to enter night flight.

### CROSS-REFERENCE TO RELATED APPLICATION

This application is a continuation of International Application No. PCT/CN2018/078257, filed on Mar. 7, 2018, the entire content of which is incorporated herein by reference.

### TECHNICAL FIELD

The present disclosure relates to the technical field of unmanned aerial vehicle technology and, more particularly, to a method and a device for night flight management of an unmanned aerial vehicle (UAV).

### BACKGROUND

With the advancement of the UAV technology, UAVs are widely used to perform a variety of tasks (e.g., aerial photographing, surveying, plant protection, etc.). Currently, the UAVs often operate within a visible range of UAV users. However, at night, due to lack of light, the users are unable to observe flight status of the UAVs. In addition, obstacle avoidance device disposed at the UAVs are unable to effectively sense obstacles in surrounding environment. As such, the UAVs operated at night are likely to be involved in safety accidents.

### SUMMARY

In accordance with the disclosure, there is provided a night flight management method for an unmanned aerial vehicle (UAV) including determining whether the UAV is in night flight or is about to enter night flight, and performing a flight control operation in response to determining that the UAV is in night flight or is about to enter night flight.

Also in accordance with the disclosure, there is provided a night flight management device for an unmanned aerial vehicle (UAV) including a memory storing program instructions and a processor configured to invoke the program instructions to determine whether the UAV is in night flight or is about to enter night flight, and perform a flight control operation in response to determining that the UAV is in night flight or is about to enter night flight.

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a flowchart of a night flight management method for an unmanned aerial vehicle (UAV) according to an example embodiment of the present disclosure.

FIG. 2 is a schematic diagram of a night flight management device disposed at a UAV or a control terminal of a UAV according to an example embodiment of the present disclosure.

FIG. 3 is a flowchart of a night flight management method for a UAV according to another example embodiment of the present disclosure.

FIG. 4 is a schematic diagram of obtaining a current flight time of a UAV by a night flight management device according to an example embodiment of the present disclosure.

FIG. 5 is a schematic diagram of obtaining a current flight time of a UAV by a night flight management device according to another example embodiment of the present disclosure.

FIG. 6 is a flowchart of a night flight management method for a UAV according to another example embodiment of the present disclosure.

FIG. 7 is a flowchart of a night flight management method for a UAV according to another example embodiment of the present disclosure.

FIG. 8 is a flowchart of a night flight management method for a UAV according to another example embodiment of the present disclosure.

FIG. 9 is a schematic diagram showing obtaining a night flight certificate according to an example embodiment of the present disclosure.

FIG. 10 is a schematic diagram showing uploading the obtained night flight certificate to a UAV according to an example embodiment of the present disclosure.

FIG. 11 is a flowchart of a night flight management method for a UAV according to another example embodiment of the present disclosure.

FIG. 12 is a flowchart of a method for determining a sunrise time and/or a sunset time according to an example embodiment of the present disclosure.

FIG. 13 is a structural block diagram of a night flight management device or a device for determining the sunrise time and/or the sunset time according to an example embodiment of the present disclosure.

### DETAILED DESCRIPTION OF THE EMBODIMENTS

Embodiments of the present disclosure are described in detail below with reference to the accompanying drawings. Same or similar reference numerals in the drawings represent the same or similar elements or elements having the same or similar functions throughout the specification. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

It should be noted that when a first component is “fixed to” a second component, the first component may be directly attached to the second component or may be separately by other intermediate components. When the first component is “connected to” to the second component, the first component may be directly connected to the second component or may be separately by other intermediate components.

Unless otherwise defined, all technical and scientific terms used herein have the same meaning as commonly understood by one of ordinary skill in the art to which this invention pertains. The terms used in the description of the present invention are merely for the purpose of describing specific embodiments, and Is not intended to limit the present invention. The term “and/or” as used herein includes any and all combinations of one or more of the associated list items.

Hereinafter, some embodiments of the present disclosure will be described in detail with reference to the drawings. In the case of no conflict, the following embodiments can be combined with each other.

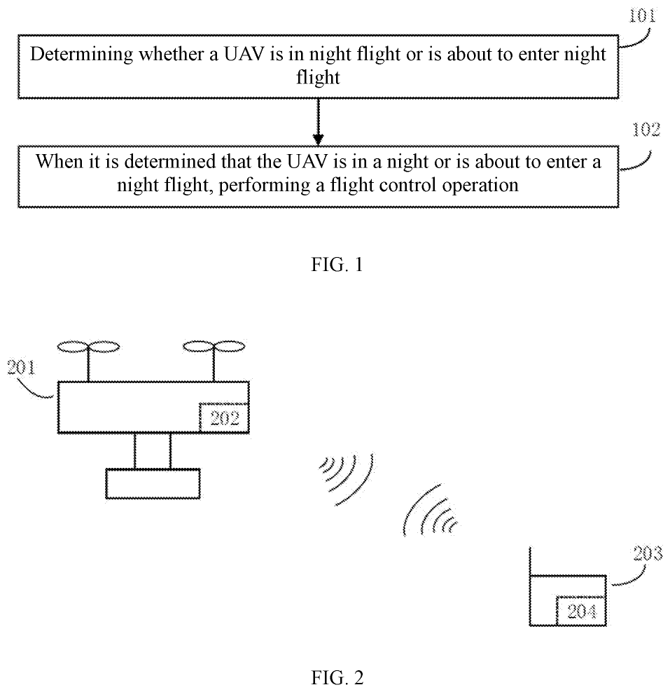

The present disclosure provides a night flight management method for an unmanned aerial vehicle (UAV). FIG. 1 is a flowchart of a night flight management method for a UAV according to an example embodiment of the present disclosure. As shown in FIG. 1, the method includes the following.

At S101, whether a UAV is currently in a night flight or is about to enter a night flight is determined.

In the embodiments of the present disclosure, the method may be performed by a night flight management device of the UAV. Further, the method may be performed by a processor of the night flight management device. The processor may be a general-purpose processor or a special-purpose processor. As shown in FIG. 2, the UAV system includes a UAV 201. In some embodiments, the night flight management device 202 is disposed at the UAV 201. The UAV system further includes a control terminal 203 for the UAV 201. In some embodiments, the night flight management device 204 is disposed at the control terminal 203 for the UAV 201. The control terminal may be one or more of a remote controller, a smart phone, a tablet computer, a laptop computer, a desktop computer, and a wearable device (a watch or a wrist-band, etc.), which is not limited by the present disclosure.

Specifically, the night flight management device needs to determine whether the UAV is currently in the night flight or is about to enter the night flight. There are multiple ways of determining whether the UAV is in the night flight or is about to enter the night flight. In some embodiments, a light intensity in a current flight area of the UAV may be used to determine whether the UAV is in the night flight or is about to enter the night flight. Further, the night flight management device obtains the light intensity in the current flight area of the UAV by a light intensity sensor and determines whether the UAV is in the night flight or is about to enter the night flight based on the light intensity. The current flight area of the UAV may be an area where the UAV is currently located. Generally, if the current flight area of the UAV has a low light intensity, it indicates that the UAV is in the night flight or is about to enter the night flight. The light intensity sensor may be a photoresistor. The light intensity sensor may be disposed at the UAV. In some embodiments, the light intensity sensor may be disposed at the control terminal of the UAV, which is not limited by the present disclosure. In some embodiments, whether the UAV is in the night flight or is about to enter the night flight is determined based on a current flight time of the UAV, which will be explained in detail later in the specification.

At S102, when the UAV is in the night flight or is about to enter the night flight, a flight control operation is performed.

Specifically, when the night flight management device determines that the UAV is in the night flight or is about to enter the night flight, it is considered that the flight safety risk increases during the flight of the UAV and a flight accident may occur. Thus, the flight control operation is performed to reduce the possibility of a safety accident of the UAV.

In some embodiments, performing the flight control operation includes displaying an alarm message on an interaction interface of the control terminal of the UAV. Specifically, the night flight management device is disposed at the control terminal of the UAV. When it is determined that the UAV is in the night flight or is about to enter the night flight, the night flight management device displays the alarm message on the interaction interface of the control terminal of the UAV to alert a user of the UAV. The alarm message may be information that alerts the user that the UAV is in the night flight or is about to enter the night flight. In addition, the alarm message may also prompt the user of one or more of information for operating the UAV to return to the home base, information for operating the UAV to land, and information for restricting the flight altitude, the flight speed, and/or flight distance of the UAV.

Further, when it is determined that the UAV is in the night flight or is about to enter the night flight, displaying the alarm message on the interaction interface of the control terminal of the UAV includes, when it is determined that the UAV is in the night flight, displaying the alarm message on the interaction interface of the control terminal of the UAV to prompt the user that the UAV is in the night flight. Specifically, when the night flight management device determines that the UAV is in the night flight, the night flight management device displays the alarm message on the interaction interface of the control terminal of the UAV to prompt the user that the UAV is in the night flight. In addition, the alarm message may also prompt the user of one or more of information for operating the UAV to return to the home base, information for operating the UAV to land, and information for restricting the flight altitude, the flight speed, and/or flight distance of the UAV.

Further, when it is determined that the UAV is in the night flight or is about to enter the night flight, displaying the alarm message on the interaction interface of the control terminal of the UAV includes, when it is determined that the UAV is about to enter the night flight, displaying the alarm message on the interaction interface of the control terminal of the UAV to prompt the user that the UAV is about to enter the night flight. Specifically, when the night flight management device determines that the UAV is about to enter the night flight, the night flight management device displays the alarm message on the interaction interface of the control terminal of the UAV to prompt the user that the UAV is about to enter the night flight. In addition, the alarm message may also prompt the user of one or more of information for operating the UAV to return to the home base, information for operating the UAV to land, and information for restricting the flight altitude, the flight speed, and/or flight distance of the UAV.

In some embodiments, performing the flight control operation includes sending the alarm message to the control terminal of the UAV. Specifically, the night flight management device is disposed at the UAV. When it is determined that the UAV is in the night flight or is about to enter the night flight, the night flight management device sends the alarm message to the control terminal of the UAV. After receiving the alarm message, the control terminal of the UAV displays the alarm message on the interaction interface of the control terminal of the UAV. The alarm message is used to prompt the user that the UAV is in the night flight or is about to enter the night flight. In addition, the alarm message may also prompt the user of one or more of information for operating the UAV to return to the home base, information for operating the UAV to land, and information for restricting the flight altitude, the flight speed, and/or flight distance of the UAV.

In some embodiments, performing the flight control operation includes restricting one or more of a flight altitude, a flight distance, a flight area range, a flight length, and a flight speed of the UAV. Specifically, when the night flight management device determines that the UAV is in the night flight or is about to enter the night flight, the night flight management device restricts the flight behavior of the UAV and the UAV flies under restricted conditions. The night flight management device restricts one or more of the flight altitude, the flight distance, the flight area range, the flight length, and the flight speed of the UAV. For example, the flight altitude of the UAV is restricted under 10 meters. That is, the maximum flight altitude of the UAV is 10 meters. Restricting one or more of the flight altitude, the flight distance, the flight area range, the flight length, and the flight speed of the UAV may reduce the possibility of the flight accident to a certain extent.

In some embodiments, performing the flight control operation includes one or more of controlling the UAV to return to the home base, controlling the UAV to land, and prohibiting the UAV from taking off. Specifically, when the night flight management device determines that the UAV is in the night flight or is about to enter the night flight, the night flight management device may perform one or more of controlling the UAV to return to the home base, controlling the UAV to land, and prohibiting the UAV from taking off. For example, if the UAV is flying, the night flight management device may control the UAV to return to the home base or control the UAV to land, such that the UAV is prevented from continuing to fly. In another example, when the UAV is standby, the night flight management device may prohibit the UAV from taking off.

In the embodiments of the present disclosure, when it is determined that the UAV is in the night flight or is about to enter the night flight, the flight control operation is performed. As such, the night flight of the UAV is managed to reduce the possibility of the flight accident of the UAV.

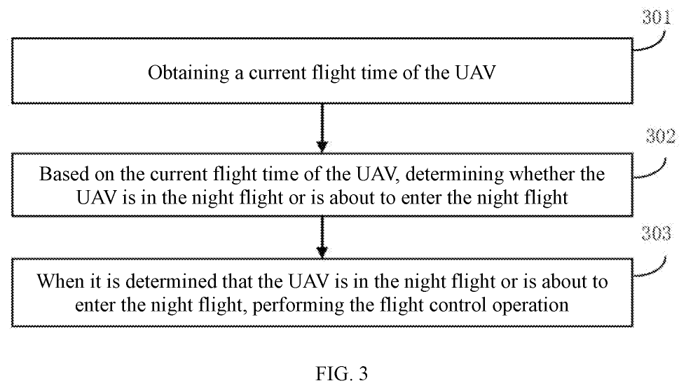

The present disclosure provides another night flight management method for the UAV. FIG. 3 is a flowchart of a night flight management method for a UAV according to another example embodiment of the present disclosure. As shown in FIG. 3, based on the embodiments shown in FIG. 1, the method further includes the following.

At S301, a current flight time of the UAV is obtained.

Specifically, to determine whether the UAV is in the night flight or is about to enter the night flight, the current flight time of the UAV is obtained, that is, determining the current time. For example, the obtained current flight time of the UAV is 20:15 or 17:10. There are multiple ways of obtaining the current flight time of the UAV.

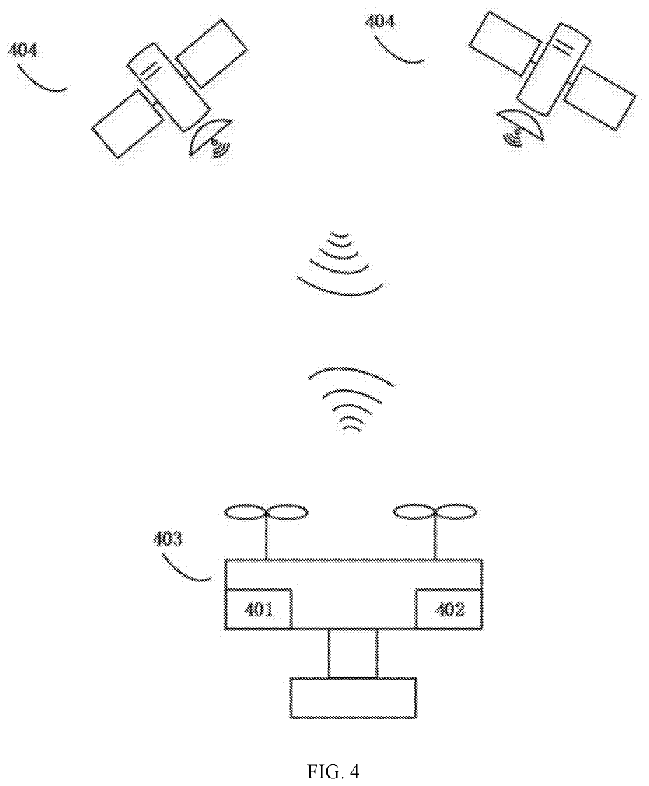

In some embodiments, the current flight time of the UAV is obtained by a satellite positioning receiving device. Specially, the satellite positioning receiving device is disposed at the UAV or at the control terminal of the UAV. The satellite positioning receiving device may be a GNSS satellite positioning receiver, a GPS positioning receiver, or a Beidou positioning receiver, etc. The satellite positioning receiving device supports a timing function. The night flight management device obtains the current flight time of the UAV from the satellite positioning receiving device. For example, as shown in FIG. 4, when the night flight management device 401 and the satellite positioning receiving device 402 are disposed at the UAV 403, the satellite positioning receiving device 402 receives a satellite signal sent by a satellite 404. Based on the satellite signal, the satellite positioning receiving device 402 determines the current flight time of the UAV. The night flight management device 401 obtains time information outputted by the satellite positioning receiving device 402 disposed at the UAV 403 and determines the current flight time of the UAV based on the outputted time information. In another example, when the night flight management device is disposed at the control terminal of the UAV, the UAV sends the time information outputted by the satellite positioning receiving device to the control terminal of the UAV. The control terminal of the UAV determines the current flight time of the UAV based on the outputted time information.

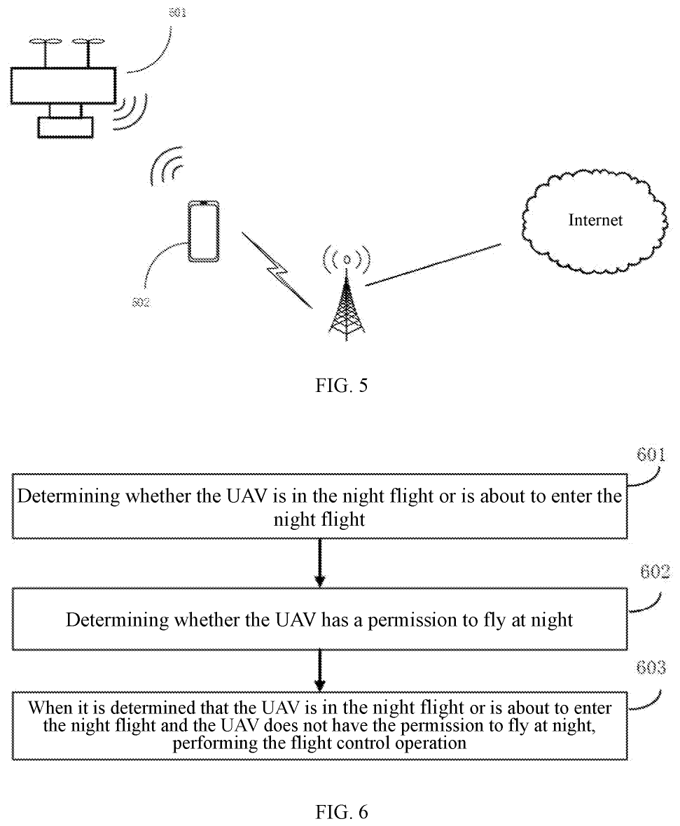

In some embodiments, the current flight time of the UAV is obtained from a mobile communication network. Specifically, the night flight management device includes a communication interface connected to the Internet. The communication interface obtains the time information from the Internet through the mobile communication network. Based on the time information, the night flight management device determines the current flight time of the UAV. For example, as shown in FIG. 5, the night flight management device (not shown) is disposed at the control terminal of the UAV 501. For example, the control terminal includes a smart phone. The smart phone obtains the time information form the Internet through the mobile communication network and determines the current flight time of the UAV based on the time information.

At S302, whether the UAV is in the night flight or is about to enter the night flight is determined based on the flight time.

Specifically, after the current flight time of the UAV is obtained, the night flight management device determines whether the UAV is in the night flight or is about to enter the night flight. For example, when the obtained current flight time of the UAV is 17:01, it is determined that the UAV is about to enter the night flight. In another example, when the obtained current flight time of the UAV is 19:50, it is determined that the UAV is in the night flight.

At S303, when it is determined that the UAV is in the night flight or is about to enter the night flight, the flight control operation is performed.

Specifically, the operation principle and the description of S303 are the same as those of S102, and details are not repeated herein.

In the embodiments of the present disclosure, the night flight management device obtains the current flight time of the UAV and determines whether the UAV is in the night flight or is about to enter the night flight based on the current flight time. When it is determined that the UAV is in the night flight or is about to enter the night flight, the flight control operation is performed. As such, whether the UAV is in the night flight or is about to enter the night flight is accurately determined, the night flight of the UAV is managed, and the possibility of the flight accident of the UAV is reduced.

The present disclosure provides another night flight management method for the UAV. FIG. 6 is a flowchart of a night flight management method for a UAV according to another example embodiment of the present disclosure. As shown in FIG. 6, based on the embodiments shown in FIG. 1, the method further includes the following.

At S601, whether the UAV is in the night flight or is about to enter the night flight is determined.

Specifically, the operation principle and the description of S601 are the same as those of S101, and details are not repeated herein.

At S602, whether the UAV has permission to fly at night is determined.

Specifically, in addition to determining whether the UAV is in the night flight or is about to enter the night flight, the night flight management device further determines whether the UAV has the permission to fly at night (also referred to as a “night-flight permission”). The permission to fly at night is related to one or more of whether the UAV has the permission to fly at night approved by a flight regulatory agency, a model of the UAV, user information of the UAV, hardware configuration of the UAV (e.g., whether the UAV includes a sensing system ensuring night flight safety of the UAV), and position information of the current flight area of the UAV. Specifically, there are multiple ways of determining whether the UAV has the permission to fly at night.

In some embodiments, whether the UAV has the permission to fly at night approved by the flight regulatory agency is determined. Specifically, the night flight management device determines whether the UAV has the permission to fly at night approved by the flight regulatory agency. When the UAV needs to fly at night, the user of the UAV submits an application to the flight regulatory agency. For example, the user of the UAV submits application information of the night flight to the flight regulatory agency. The flight regulatory agency reviews the application information of the night flight. If the flight regulatory agency approves the application, the UAV obtains the permission to fly at night approved by the flight regulatory agency. The flight regulatory agency may be an agency that regulates the airspace, such as a civil aviation administration.

In some embodiments, the model information of the UAV is obtained and based on the model information, where the UAV has the permission to fly at night is determined. Specifically, the UAV may have various models, such as a model for performing aerial photographing tasks, a model for performing plant protection tasks, a model for performing inspection tasks (e.g., electric grid inspection, pipeline inspection), and a model for performing surveying and mapping tasks. Some models may have the permission to fly at night. Some other models may not have the permission to fly at night. Further, the UAVs include consumer models and industrial models. Depending on the model, the UAV may or may not have the permission to fly at night. For example, the model for performing the inspection tasks has the permission to fly at night. The model for performing the aerial photographing tasks does not have the permission to fly at night. Further, the UAVs of the consumer models often do not have the permission to fly at night while the UAVs of the industrial models often have the permission to fly at night. The night flight management device obtains the model information of the UAV and based on the obtained model information of the UAV, determines whether the UAV is the model that has the permission to fly at night. When it is determined that the obtained model is the model that has the permission to fly at night, it is determined that the UAV has the permission to fly at night. When it is determined that the obtained model is the model that does not have the permission to fly at night, it is determined that the UAV does not have the permission to fly at night. For example, when the determined model of the UAV is the model for performing the inspection tasks, it is determined that the UAV has the permission to fly at night. When the determined model of the UAV is the model for performing the aerial photographing tasks, it is determined that the UAV does not have the permission to fly at night. In another example, when the obtained model of the UAV is the industrial model, it is determined that the UAV has the permission to fly at night. When the obtained model of the UAV is the consumer model, it is determined that the UAV does not have the permission to fly at night.

In some embodiments, the user information of the UAV is obtained, and based on the user information, whether the UAV has the permission to fly at night is determined. Specifically, the UAV may have various users, such as an ordinary consumer (e.g., an individual user), an industrial user (e.g., a construction company, an electricity utility company, or a plant protection institute, etc.), a scientific user (e.g., a university, or a research institute, etc.), or an agency user (e.g., a government agency, etc.) Depending on the user, the UAV of a certain user has the permission to fly at night and the UAV of a different user does not have the permission to fly at night. For example, the UAVs of the industrial users and the agency users have the permission to fly at night, and the UAVs of the ordinary users do not have the permission to fly at night. The night flight management device obtains the user information of the UAV and based on the obtained user information of the UAV, determines whether the UAV of the user indicated by the user information has the permission to fly at night. For example, the night flight management device obtains the user information of the UAV. If the user indicated by the user information is the industrial user, it is determined that the UAV has the permission to fly at night. If the user indicated by the user information is the ordinary user, it is determined that the UAV does not have the permission to fly at night.

In some embodiments, whether the UAV includes the sensing system ensuring the night flight safety of the UAV is determined. When the UAV does not include the sensing system ensuring the night flight safety of the UAV, it is determined that the UAV does not have the permission to fly at night. Specifically, when the UAV is in the night flight, the user is unable to observe the status of the UAV (e.g., the current position, the nose orientation, the flight altitude of the UAV) and the surrounding environment of the UAV, and the flight accident is likely to occur during the flight of the UAV. Some UAVs include the sensing system ensuring the flight safety of the UAV, such as a binocular or a monocular obstacle avoidance sensing system, which is unable to effectively sense the surrounding environment under low light at night and loses the ability of ensuring the flight safety. Some UAVs include the sensing system ensuring the night flight safety of the UAV, such as an obstacle avoidance sensing system that operates independent of ambient light (e.g., a millimeter-wave radar). Even at night, the UAV including the ambient-light-independent sensing system is still able to effectively sense the surrounding environment through the ambient-light-independent sensing system. For example, the UAV is able to effectively sense obstacles in the surrounding environment to ensure the night flight safety of the UAV. The night flight management device determines whether the UAV includes the sensing system ensuring the night flight safety of the UAV. When the UAV does not include the ambient-light-independent sensing system, it is determined that the UAV does not have the permission to fly at night. When the UAV includes the ambient-light-independent sensing system, it is determined that the UAV has the permission to fly at night.

In some embodiments, the position information of the current flight area of the UAV is determined, and based on the position information, whether the UAV has the permission to fly at night is determined. Specifically, the UAV or the control terminal of the UAV may be including the satellite positioning receiving device. The position information of the current flight area of the UAV is obtained by the satellite positioning receiving device. Based on the position information, whether the UAV has the permission to fly at night is determined. For example, when the position information indicates that the UAV is flying at a no-fly zone or near the no-fly zone, the UAV does not have the permission to fly at night. In another example, based on the position information, which country the current flight area of the UAV is located is determined. That is, which country the UAV is currently located is determined. Certain countries do not allow the users to operate the UAVs at night. Certain other countries allow, or allow with conditions, the users to operate the UAVs at night. After it is determined that which country the current flight area of the UAV is located and the determined country does not allow the users to operate the UAVs at night, it is determined that the UAV does not have the permission to fly at night. After it is determined that which country the current flight area of the UAV is located and the determined country allows the users to operate the UAVs at night, it is determined that the UAV has the permission to fly at night.

In the embodiments of the present disclosure, the execution order of S601 and S602 is not limited, may be performed one after the other, or may be performed at the same time.

At S603, when it is determined that the UAV is in the night flight or is about to enter the night flight and the UAV does have the permission to fly at night, the flight control operation is performed.

Specifically, when the night flight management device determines that the UAV is in the night flight or is about to enter the night flight, and further determines that the UAV does not have the permission to fly at night, the night flight management device performs the flight control operation.

In the embodiments of the present disclosure, whether the UAV has the permission to fly at night is determined. If the UAV does not have the permission to fly at night, the flight control operation is performed when it is determined that the UAV is in the night flight or is about to enter the night flight, thereby reducing the possibility of the flight accident.

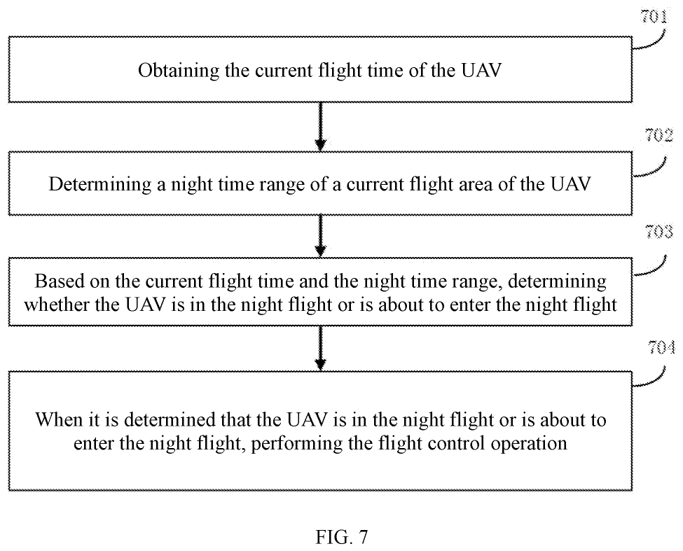

The present disclosure provides another night flight management method for the UAV. FIG. 7 is a flowchart of a night flight management method for a UAV according to another example embodiment of the present disclosure. As shown in FIG. 7, based on the embodiments shown in FIG. 3, the method further includes the following.

At S701, a current flight time of the UAV is obtained.

Specifically, the operation principle and the description of S701 are the same as those of S301, and details are not repeated herein.

At S702, a night time range of the current flight area of the UAV is determined.

Specifically, to determine whether the UAV is in the night flight or is about to enter the night flight, the night flight management device determines the night time range of the current flight area of the UAV, that is, the night time period of the current flight area of the UAV. In some cases, the night time range is defined as between an evening time of a day and a morning time of a subsequent day. In some other cases, the night time range is defined by the light intensity of the current flight area of the UAV.

In some embodiments, determining the night time range of the current flight area of the UAV includes determining the sunrise time and the sunset time of the current flight area of the UAV and based on the sunrise time and the sunset time, determining the night time range of the current flight area of the UAV. Specifically, the night flight management device determines the sunrise time and the sunset time of the current flight area of the UAV, that is, a time of day sun rises and a time of day sun sets in the current flight area of the UAV. Then, based on the sunrise time and the sunset time, the night time range is determined. For example, the time period between the sunset time of the day and the sunrise time of the subsequent day is determined to be the night time range.

In some embodiments, determining the sunrise time and the sunset time of the current flight area of the UAV includes obtaining the position information of the current flight area of the UAV, and based on the position information, determining the sunrise time and the sunset time of the current flight area f the UAV. Specifically, the sunrise time and the sunset time vary with the position on the earth. The night flight management device obtains the position information of the UAV or the control terminal of the UAV through the satellite positioning receiving device disposed at the UAV or at the control terminal of the UAV and makes the position information as the position information of the current flight area of the UAV. The position information includes at least latitude information. Based on the position information, the sunrise time and the sunset time of the current flight area of the UAV is further determined. For example, the night flight management device obtains the position information of the current flight area of the UAV. The position information indicates that the flight area is in Hong Kong. Based on the position information, it is determined that the sunrise time is 6:50 and the sunset time is 18:24. In another example, the night flight management device obtains the position information of the current flight area of the UAV. The position information indicates that the flight area is in Vancouver. Based on the position information, it is determined that the sunrise time is 7:08 and the sunset time is 17:44.

In some embodiments, the night flight management device obtains current calendar information. Determining the sunrise time and the sunset time of the current flight area of the UAV based on the position information includes, based on the position information and the calendar information, determining the sunrise time and the sunset time of the current flight area of the UAV. Specifically, for a same flight area, the sunrise time and the sunset time of the flight area vary with seasons. In addition to the position information of the current flight area of the UAV, the night flight management device also obtains the current calendar information. Based on the position information and the calendar information, the sunrise time and the sunset time of the current flight area of the UAV is determined. The calendar information indicates the month of a year or the day of a month. The calendar information may be obtained from the satellite positioning receiving device disposed at the UAV or at the control terminal of the UAV. The calendar information may also be obtained through the mobile communication network, for example, from the Internet through the mobile communication network.

In some embodiments, the night flight management device also obtains the current altitude of the UAV or the control terminal of the UAV and determining the sunrise time and the sunset time of the current flight area of the UAV based on the position information and the calendar information includes, based on the position information, the altitude, and the calendar information, determining the sunrise time and the sunset time of the current flight area of the UAV. Specifically, the current altitude of the UAV or the control terminal of the UAV affects the sunrise time and the sunset time. The current altitude of the UAV or the control terminal of the UAV can be used as the altitude of the current flight area of the UAV. Then, based on the position information, the altitude, and the calendar information, the sunrise time and the sunset time of the current flight area of the UAV is determined. Obtaining the current altitude of the UAV or the control terminal of the UAV includes obtaining air pressure data outputted by an air pressure sensor disposed at the UAV or the control terminal of the UAV and based on the air pressure data, determining the altitude. In some embodiments, the air pressure sensor is a barometer.

In some embodiments, determining the sunrise time and the sunset time of the current flight area of the UAV based on the position information, the altitude, and the calendar information includes determining a current declination of the Earth based on the calendar information, determining a solar hour angle based on the position information, determining a time correction amount based on the altitude, and determining the sunrise time and the sunset time of the current flight area of the UAV based on the current Earth declination, the solar hour angle, and the time correction amount. The process of determining the sunrise time and the sunset time will be described in detail below.

To calculate the sunrise time and the sunset time, a current declination of the Earth is obtained. The calculation equation is as follows:

δ=−δₘₐₓ*cos(ω_{Earth}_{ᵣₑᵥₒₗᵤₜᵢₒₙ}*(N+10)),

where δ is the current declination of the Earth, δ is zero when the sun is directly above the equator, δ is positive when the sun is above the northern hemisphere, and δ is negative when the sun is above the southern hemisphere; δₘₐₓ is the maximum declination of the Earth and has a constant value 23°26′, i.e., about 23.45°; ω_{Earth}_{ᵣₑᵥₒₗᵤₜᵢₒₙ} is the angular velocity of the Earth's revolution, and the Earth rotates one revolution in one year or about 365 days, i.e., ω_{Earth}_{ᵣₑᵥₒₗᵤₜᵢₒₙ}=360°/365; and N is a day number in a year and is determined based on the calendar. For example, January 1 is day number 1 and so on so forth.

The latitude of the current flight area of the UAV is denoted as ψ. ψ is zero at the equator. ψ is positive at the northern hemisphere. ψ is negative at the southern hemisphere.

ψ≤−90°+δ or ψ≥90°+δ indicates a polar night, that is, the night is 24 hours a day. ψ≤−90°−δ or ψ≥90°−δ indicates a polar day, that is, the day is 24 hours a day. When −90°+δ≤<ψ<90°−δ, the day and the night are alternated. The calculation method of the sunrise time and the sunset time is as follows:

$${T}_{sunrise} = 12 - \frac{{ω}_{0}}{{ω}_{earth rotation}} - {T}_{altitude} , \\ {T}_{sunset} = 12 + \frac{{ω}_{0}}{{ω}_{earth rotation}} + {T}_{altitude} ,$$

where ω₀ is the solar hour angle at the sunrise or the sunset and is determined by the latitude w of the current flight area of the UAV, T sunrise is the actual sunrise time at certain day and certain location, Tₛᵤₙₛₑₜ is the actual sunset time at certain day and certain location, ω_{earth rotation} is the rotation speed of the Earth, that is, 24 hours a day or 15°/hour, T_{altitude} is a time correction amount, that is, the sunrise/sunset time deviation caused by the altitude variation.

Further,

$$cos ( {ω}_{0} ) = \frac{sin α - sin ψ \times sin δ}{cos ψ \times cos δ} ,$$

where α is the angle of the sun below the horizontal plane at the sunrise/sunset.

Further,

$$α = {ω}_{refringence} + \frac{{Φ}_{sun}}{2} ,$$

where ω_{refringence} is the angle at which the sun is lifted due to atmospheric refraction and is about 0.6°, Φₛᵤₙ is the angle of the sun disk surface and is about 0.5°. Thus, α=−(0.6°+0.5°/2)=0.85°.

The altitude variation affects the sunrise time and the sunset time. As such, the sunrise time and the sunset time need to be modified based on the altitude, that is:

$${T}_{altitude} = \frac{arc cos ( \frac{{R}_{earth}}{{R}_{earth} + {H}_{altitude \_ ref}} ) - arc cos ( \frac{{R}_{earth}}{{R}_{earth} - {H}_{altitude \_ UA}} )}{{ω}_{earth rotation}} ,$$

where Rₑₐᵣₜₕ is the radius of the Earth assuming the Earth is spherical, H_{altitude_ref} is the altitude of the sea level at the standard atmospheric pressure, that is, H_{altitude_ref}=⁰, H_{altitude_UA} is the altitude of the UAV or the control terminal of the UAV, the actual altitude is often greater than 0, and H_{altitude_UA}=0 when the altitude is below the sea level.

According to the above calculation method, the sunrise time and the sunset time of the current flight area of the UAV can be calculated.

At S703, based on the flight time and the night time range, whether the UAV is in the night flight or is about to enter the night flight is determined.

Specifically, after the night time range is determined, whether the flight time is within the night time range is determined. When it is determined that the flight time is within the night time range, it is determined that the UAV is in the night flight. When the flight time is close to the night time range, it is determined that the UAV is about to enter the night flight. Further, determining whether the UAV is about to enter the night flight based on the flight time and the night time range includes obtaining a trip time, a remaining trip time, or a returning trip time of the UAV, determining whether the UAV is about to enter the night flight based on any of the trip time, the remaining trip time, and the returning trip time, and the current flight time of the UAV. Specifically, if the current flight time of the UAV is outside the night time range, the night flight management device obtains the trip time, the remaining trip time, or the returning trip time. The trip time is the longest time the UAV can fly. The remaining trip time is determined based on the remaining power capacity of the UAV. The returning trip time is determined by one or more of a distance between the UAV's current position and the home base, a returning speed, and a wind speed. The night time flight management device determines whether a sum of the current flight time of the UAV and either of the trip time, the remaining trip time, or the returning trip time of the UAV is within the night time range. If within the night time range, it is determined that the UAV is about to enter the night flight.

It should be understood that the embodiments of the present disclosure do not limit an order of performing S701 and S702. S701 and S702 may be performed sequentially or concurrently.

At S704, when it is determined that the UAV is in the night flight or is about to enter the night flight, the flight control operation is performed.

Specifically, the operation principle and the description of S704 are the same as those of S102 or S603, and details are not repeated herein.

In the embodiments of the present disclosure, the night flight management device accurately determines whether the UAV is in the night flight or is about to enter the night flight based on the night time range of the current flight area of the UAV and the current flight time. When it is determined that the UAV is in the night flight or is about to enter the night flight, the flight control operation is performed. As such, the night flight of the UAV is managed, and the possibility of the flight accident of the UAV is reduced.

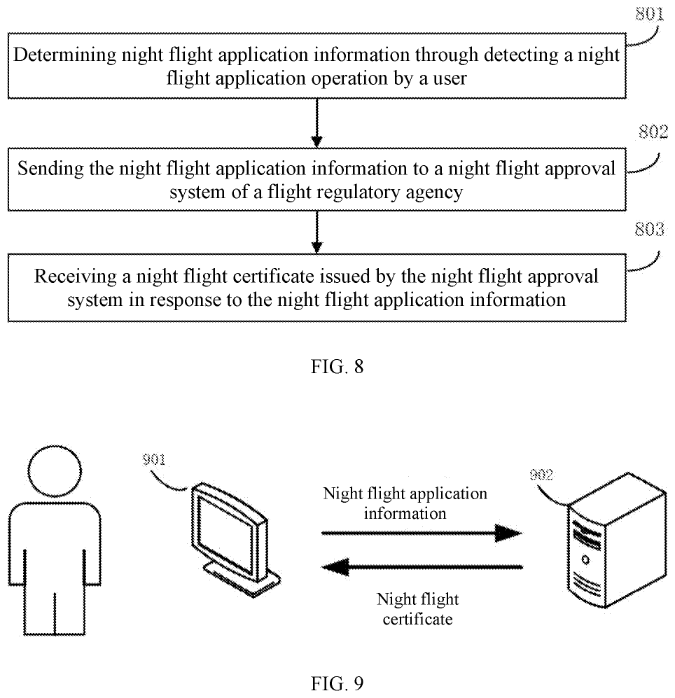

The present disclosure provides another night flight management method for the UAV. FIG. 8 is a flowchart of a night flight management method for a UAV according to another example embodiment of the present disclosure. As shown in FIG. 8, the method further includes the following.

At S801, night flight application information is determined by detecting a night flight application operation by a user.

In the embodiments of the present disclosure, the method may be performed by a night flight management device of the UAV. Further, the method may be performed by a processor of the night flight management device. The processor may be a general-purpose processor or a special-purpose processor. In some embodiments, the night flight management device is disposed at the terminal device. Further, the terminal device may be the control terminal of the UAV. The terminal device may be one or more of a remote controller, a smart phone, a tablet computer, a laptop computer, a desktop computer, and a wearable device (a watch or a wrist-band, etc.).

Specifically, as shown in FIG. 9, when a user plans to operate the UAV at night, the user submits the night flight application information to the flight regulatory agency through a night flight management device 901. The night flight management device includes interaction devices, such as one or more of a touch screen, a keyboard, a push button, a scroll wheel, and a joystick. The user performs the night flight application operation on the interaction device to submit the night flight application information. A processor of the night flight management device 901 detects the night flight application operation by the user through the interaction device and obtains the night flight application information.

In some embodiments, the night flight application information includes one or more of a night flight time, a type of operation tasks, a flight route, position information of the flight area, a model, a serial number, user information, a flight length, a flight altitude, and a flight speed of the UAV. For example, the user submits the night flight application information through the night flight management device. The night flight application information includes the night flight time of the UAV, such as from 9:00 pm through 10:00 pm on Apr. 5, 2018 and the position information of the flight area such as Nanshan District, Shenzhen.

At S802, the night flight application information is sent to a night flight approval system of the flight regulatory agency.

Specifically, after the night flight application information is determined, the night flight management device 901 sends the night flight application information to the night flight approval system of the flight regulatory agency, that is, reports a night flight plan to the flight regulatory agency, such that the night flight plan is registered or an approval for the night flight plan by the flight regulatory agency is requested. The night flight approval system 902 of the flight regulatory agency may be at least one of a night flight approval mail system, a server of the flight regulatory agency, or a terminal device of the flight regulatory agency. The night flight approval system 902 of the flight regulatory agency obtains the night flight plan of the user after receiving the night flight application information.

At S803, a night flight certificate for the night flight application information sent by the night flight approval system is received.

Specifically, different countries or regions may have different rules of operating the UAV at night. In some cases, according to operation rules, the user is only required to report the night flight to the flight regulatory agency. That is, the user is only required to complete the registration of the night flight plan. After receiving the night flight application information, the approval system issues the night flight certificate to the night flight management device 901. The user legally operates the UAV to complete the night flight corresponding to the night flight application information. In some other cases, according to the operation rules, the user is required to report the night flight plan to the flight regulatory agency and get the approval from the flight regulatory agency before the user can legally operate the UAV at night. After the night flight approval system receives the night flight application information, the night flight approval system automatically approves the night flight application. Alternatively, a staff of the flight regulatory agency manually approves the night flight application through the approval system 902 of the flight regulatory agency. After the approval, the approval system 902 of the flight regulatory agency issues the night flight certificate to the night flight management device. After the night flight management device 901 receives the night flight certificate, the user may legally operate the UAV to complete the night flight corresponding to the night flight application information. The night flight certificate is an electronic certificate. Further, the night flight certificate may be expressed in one or more of numbers, letters, characters, barcodes, and QR codes.

In the embodiments of the present disclosure, the night flight application information of the user is submitted to the night flight approval system of the flight regulatory agency. The night flight certificate is obtained from the night flight approval system of the flight regulatory agency. As such, the flight regulatory agency manages the night flight plan of the UAV of the user.

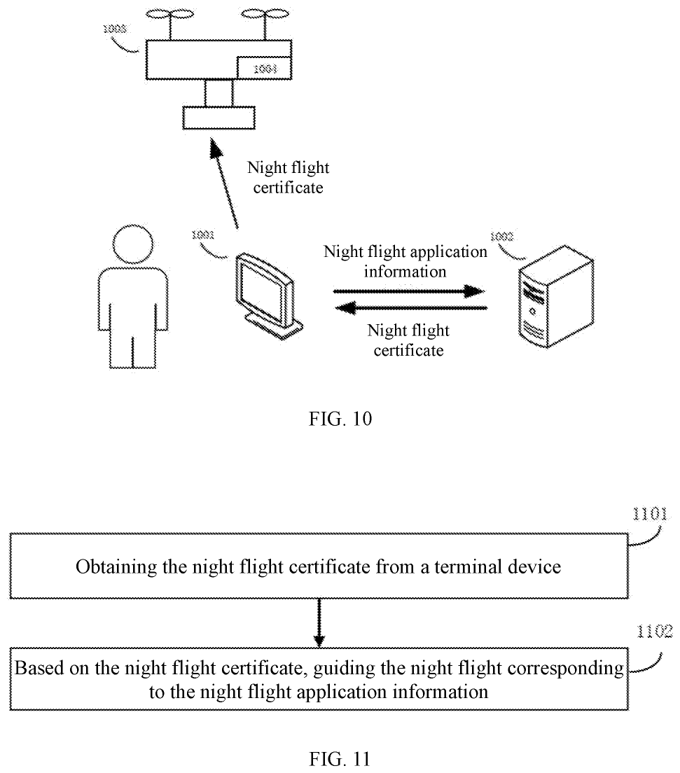

In some embodiments, after receiving the night flight electronic certificate, the night flight management device uploads the night flight certificate to the flight controller of the UAV to guide the night flight of the UAV corresponding to the night flight application information. Specifically, as shown in FIG. 10, after a night flight management device 1001 receives the night flight certificate issued by a night flight approval system 1002 of the flight regulatory agency, when the night flight management device communicates with a UAV 1003 through a wired or wireless connection, the night flight management device 1001 uploads the night flight certificate to a flight controller 1004 of the UAV 1003. The night flight certificate uploaded to the flight controller 1004 guides the night flight corresponding to the night flight application information.

Further, uploading the night flight certificate to the flight controller of the UAV to guide the night flight of the UAV corresponding to the night flight application information includes uploading the night flight certificate to the flight controller of the UAV to remove night flight restriction. Specifically, in some cases, the flight controller of the UAV includes internal configuration for restricting the night flight of the UAV, such as take-off restriction, flight altitude restriction, flight distance restriction, and flight area restriction, etc. When the night flight certificate is uploaded to the flight controller, the flight controller removes the night flight restriction. The night flight restriction may be corresponding to the night flight application information. For example, the night flight application information includes the flight area of the UAV. When the UAV is standby or is in the night flight, the satellite positioning receiving device disposed at the UAV obtains the current position information. When the current position information is within the flight area of the UAV, the flight controller removes the night flight restriction.

Further, according to the method, the night flight certificate includes night flight restriction information. Uploading the night flight certificate to the flight controller of the UAV to guide the night flight of the UAV corresponding to the night flight application information includes uploading the night flight certificate to the flight controller of the UAV to restrict the night flight of the UAV corresponding to the night flight application information according to the night flight restriction information. Specifically, the night flight certificate includes the night flight restriction information. In some embodiments, the night flight restriction information includes one or more of the flight altitude restriction, the flight area restriction, the flight time restriction, the flight length restriction, the flight speed restriction, and the flight route restriction of the UAV. When the user operates the UAV to perform the night flight corresponding to the night flight application information, the flight of the UAV is restricted according to the night flight restriction information of the night flight certificate. For example, the night flight restriction information includes the 10-meter flight altitude restriction. During the flight of the UAV, the flight altitude of the UAV is forcibly restricted to 10 meters or less.

In some embodiments, the night flight restriction information is determined based on the night flight application information. Specifically, after receiving the night flight application information, the night flight approval system of the flight regulatory agency determines the night flight restriction information based on the night flight application information. Different night flight restriction information may be determined regarding different night flight application information. For example, the night flight application information includes the position information of the flight area of the UAV. Based on the position information, the night flight approval system of the flight regulatory agency determines a distance between the flight area of the UAV and a no-fly zone, and further determines the night flight restriction information based on the distance. For example, when the distance is smaller than or equal to about 5 km, the flight altitude restriction of the night flight restriction information is determined to be 5 meters. When the distance is greater than about 5 km, the flight altitude restriction of the night flight restriction information is determined to be 10 meters.

The present disclosure provides another night flight management method for the UAV. FIG. 11 is a flowchart of a night flight management method for a UAV according to another example embodiment of the present disclosure. As shown in FIG. 11, the method further includes the following.

At S1101, a night flight certificate is obtained from a terminal device.

In the embodiments of the present disclosure, the method may be performed by a night flight management device of the UAV. Further, the method may be performed by a processor of the night flight management device. The processor may be a general-purpose processor or a special-purpose processor. The night flight management device may be disposed at the UAV.

Specifically, as shown in FIG. 8, when the user plans to operate the UAV at night, the user submits the night flight application information to the flight regulatory agency through a terminal device. After the terminal device sends the night flight application information to the night flight approval system of the flight regulatory agency, the terminal device receives the night flight certificate from the night flight approval system of the flight regulatory agency. The terminal device determines the night flight application information by detecting the night flight application operation by the user of the UAV. The night flight management device obtains the night flight certificate from the terminal device. The night flight certificate may be obtained directly or indirectly, which is not limited by the present disclosure.

At S1102, the night flight corresponding to the night flight application information is guided based on the night flight certificate.

Specifically, in some cases, the night flight management device is the flight controller of the UAV. After obtaining the night flight certificate, the flight controller guides the night flight corresponding to the night flight application information based on the night flight certificate. In some other cases, the night flight management device sends the night flight certificate obtained from the terminal device to the flight controller. Based on the night flight certificate, the flight controller guides the night flight corresponding to the night flight application information.

In some embodiments, guiding the night flight corresponding to the night flight application information based on the night flight certificate includes, based on the night flight certificate, removing the night flight restriction corresponding to the night flight application information.

In some embodiments, the night flight certificate includes the night flight restriction information. Guiding the night flight corresponding to the night flight application information includes restricting the night flight of the UAV corresponding to the night flight application information according to the night flight restriction information.

In some embodiments, the night flight restriction information is determined based on the night flight application information.

In some embodiments, the night flight restriction information includes one or more of the flight altitude restriction, the flight area restriction, the flight time restriction, the flight length restriction, the flight speed restriction, and the flight route restriction of the UAV.

It can be understood that, for specific principle of the method in the embodiments of the present disclosure, reference may be made to the foregoing corresponding parts, and details are not described herein again.

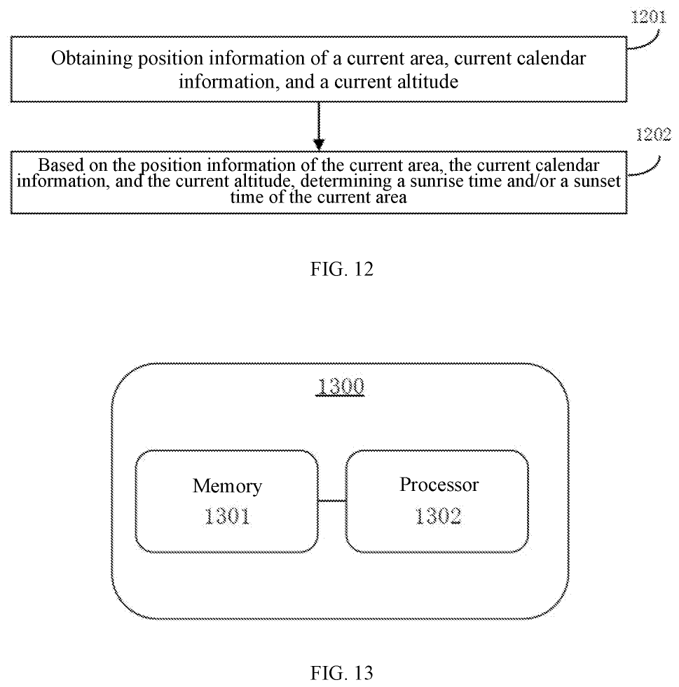

The present disclosure provides a method for determining a sunrise time and/or a sunset time. FIG. 12 is a flowchart of a method for determining a sunrise time and/or a sunset time according to another example embodiment of the present disclosure. As shown in FIG. 12, the method includes the following.

At S1201, position information of a current area, current calendar information, and a current altitude are obtained.

In the embodiments of the present disclosure, the method may be performed by a device for determining the sunrise time and/or the sunset time. Further, the method may be performed by a processor of the device for determining the sunrise time and/or the sunset time. The processor may be a general-purpose processor or a special-purpose processor. In some embodiments, the device for determining the sunrise time and/or the sunset time is disposed at the terminal device. Further, the terminal device is a control terminal of a movable platform. The movable platform may be a UAV. In some embodiments, the device for determining the sunrise time and/or the sunset time is disposed at the movable platform.

Specifically, the altitude variation affects the sunrise time and the sunset time. The device for determining the sunrise time and/or the sunset time obtains the altitude of an area where the device is located, such as the current altitude of the UAV or the control terminal of the UAV. The device for determining the sunrise time and/or the sunset time obtains the position information of the area where the device is located, such as the current position information of the UAV or the control terminal of the UAV. The device for determining the sunrise time and/or the sunset time obtains the calendar information of the area where the device is located, such as the calendar information of the current flight area of the UA.

At S1202, based on the current position information, the current calendar information, and the current altitude, the sunrise time and/or the sunset time of the current area is determined.

In some embodiments, determining the sunrise time and/or the sunset time of the current area based on the current position information, the current calendar information, and the current altitude includes determining a current declination of the Earth based on the calendar information, determining a solar hour angle based on the position information, determining a time correction amount based on the altitude, and determining the sunrise time and the sunset time of the current flight area of the UAV based on the current declination of the Earth, the solar hour angle, and the time correction amount.

In some embodiments, obtaining the current calendar information of the current area includes obtaining the current calendar information of the current area through the satellite positioning receiving device.

In some embodiments, obtaining the current calendar information of the current area includes obtaining the current calendar information of the current area through the mobile communication network.

It can be understood that, for specific principle of the method in the embodiments of the present disclosure, reference may be made to the foregoing corresponding parts, and details are not described herein again.

The present disclosure provides a night flight management device for a UAV. FIG. 13 is a structural block diagram of a night flight management device according to an example embodiment of the present disclosure. As shown in FIG. 13, the night flight management device 1300 for the UAV includes a memory 1301 storing program instructions and a processor 1302 configured to invoke the program instructions. When being executed by the processor, the program instructions cause the processor to determine whether the UAV is in the night flight or is about to enter the night flight and perform a flight control operation when it is determined that the UAV is in the night flight or is about to enter the night flight.

In some embodiments, when determining whether the UAV is in the night flight or is about to enter the night flight, the processor is configured to obtain a light intensity in a current flight area of the UAV and determine whether the UAV is in the night flight or is about to enter the night flight based on the light intensity.

In some embodiments, when determining whether the UAV is in the night flight or is about to enter the night flight, the processor is configured to obtain a current flight time of the UAV and determine whether the UAV is in the night flight or is about to enter the night flight based on the current flight time.

In some embodiments, when performing the flight control operation, the processor is configured to display an alarm message on an interaction interface of a control terminal of the UAV.

In some embodiments, when it is determined that the UAV is in the night flight or is about to enter the night flight and the alarm message is displayed on the interaction interface of the control terminal of the UAV, the processor is configured to, when it is determined that the UAV is in the night flight, display the alarm message on the interaction interface of the control terminal of the UAV to prompt the user that the UAV is in the night flight.

In some embodiments, when it is determined that the UAV is in the night flight or is about to enter the night flight and the alarm message is displayed on the interaction interface of the control terminal of the UAV, the processor is configured to, when it is determined that the UAV is about to enter the night flight, display the alarm message on the interaction interface of the control terminal of the UAV to prompt the user that the UAV is about to enter the night flight.

In some embodiments, when performing the flight control operation, the processor is configured to send the alarm message to the control terminal of the UAV.

In some embodiments, when performing the flight control operation, the processor is configured to restrict one or more of a flight altitude, a flight distance, a flight area range, a flight length, and a flight speed of the UAV.

In some embodiments, when performing the flight control operation, the processor is configured to perform one or more of controlling the UAV to return to the home base, controlling the UAV to land, and prohibiting the UAV from taking off.

In some embodiments, when obtaining the current flight time of the UAV, the processor is configured to obtain the current flight time of the UAV through a satellite positioning receiving device.

In some embodiments, when obtaining the current flight time of the UAV, the processor is configured to obtain the current flight time of the UAV through a mobile communication network.

In some embodiments, when determining whether the UAV is in the night flight or is about to enter the night flight based on the flight time, the processor is configured to obtain a night time range of the current flight area of the UAV and determine whether the UAV is in the night flight or is about to enter the night flight based on the current flight time and the night time range.

In some embodiments, when determining the night time range of the current flight area of the UAV, the processor is configured to determine a sunrise time and a sunset time of the current flight area of the UAV and determine the night time range of the current flight area of the UAV based on the sunrise time and the sunset time.

In some embodiments, when determining the sunrise time and the sunset time of the current flight area of the UAV, the processor is configured to obtain position information, an altitude, and calendar information of the current flight area of the UAV and determine the sunrise time and the sunset time of the current flight area of the UAV based on the position information, the altitude, and the calendar information.

In some embodiments, when obtaining the altitude of the current flight area of the UAV, the processor is configured to obtain the altitude of the current flight area of the UAV through an air pressure sensor disposed at the UAV or the control terminal of the UAV.

In some embodiments, the processor is configured to determine whether the UAV has a permission to fly at night.

In some embodiments, when it is determined that the UAV is in the night flight or is about to enter the night flight and the flight control operation is performed, the processor is configured to, when it is determined that the UAV is in the night flight or is about to enter the night flight and the UAV does not have the permission to fly at night, perform the flight control operation.

In some embodiments, when determining whether the UAV has the permission to fly at night, the processor is configured to determine whether the UAV has the permission to fly at night approved by a flight regulatory agency.

In some embodiments, when determining whether the UAV has the permission to fly at night approved by the flight regulatory agency, the processor is configured to determine whether the UAV has a night flight certificate issued by a night flight approval system of the flight regulatory agency and determine whether the UAV has the permission to fly at night approved by the flight regulatory agency when the UAV has the night flight certificate.

In some embodiments, when determining whether the UAV has the permission to fly at night, the processor is configured to obtain a model of the UAV and determine whether the UAV has the permission to fly at night based on the model.

In some embodiments, when determining whether the UAV has the permission to fly at night, the processor is configured to obtain user information of the UAV and determine whether the UAV has the permission to fly at night based on the user information.

In some embodiments, when determining whether the UAV has the permission to fly at night, the processor is configured to determine the position information of the current flight area of the UAV and determine whether the UAV has the permission to fly at night based on the position information.

In some embodiments, when determining whether the UAV has the permission to fly at night, the processor is configured to determine whether the UAV includes a sensing system ensuring the night flight safety of the UAV and determine that the UAV does not have the permission to fly at night when the UAV does not include the sensing system.

It can be understood that, for specific principle of the device in the embodiments of the present disclosure, reference may be made to the foregoing embodiments in FIGS. 1-7.

The present disclosure also provides a UAV including the foregoing night flight management device.

The present disclosure also provides a control terminal of the UAV including the foregoing night flight management device.

The present disclosure provides the night flight management device of the UAV. FIG. 13 is a structural block diagram of a night flight management device according to an example embodiment of the present disclosure. As shown in FIG. 13, the night flight management device 1300 of the UAV includes a memory configured to store program instructions and a processor configured to invoke the program instructions. When being executed by the processor, the program instructions cause the processor to: determine night flight application information through detecting a night flight application operation by a user, sends the night flight application information to a night flight approval system of a flight regulatory agency, and receive a night flight certificate issued by the night flight approval system in response to the night flight application information.

In some embodiments, the night flight application information includes one or more of a night flight time, a type of operation tasks, a flight route, position information of the flight area, a model, a serial number, user information, a flight length, a flight altitude, and a flight speed of the UAV.

In some embodiments, the processor is further configured to uploading the night flight certificate to a flight controller of the UAV to guide the night flight of the UAV corresponding to the night flight application information.

In some embodiments, when uploading the night flight certificate to the flight controller of the UAV to guide the night flight of the UAV corresponding to the night flight application information, the processor is further configured to upload the night flight certificate to the flight controller of the UAV to remove night flight restriction corresponding to the night flight application information.

In some embodiments, the night flight certificate includes night flight restriction information, and when uploading the night flight certificate to the flight controller of the UAV to guide the night flight of the UAV corresponding to the night flight application information, the processor is further configured to upload the night flight certificate to the flight controller of the UAV to restrict the night flight of the UAV corresponding to the night flight application information according to the night flight restriction information.

In some embodiments, the night flight restriction information is determined based on the night flight application information.

In some embodiments, the night flight restriction information includes one or more of flight altitude restriction, flight area restriction, flight time restriction, flight length restriction, flight speed restriction, and flight route restriction of the UAV.

It can be understood that, for specific principle of the device in the embodiments of the present disclosure, reference may be made to the foregoing embodiments in FIGS. 8-10.

The present disclosure also provides a terminal device including the foregoing night flight management device.

In some embodiments, the terminal device is the control terminal of the UAV.

The present disclosure provides the night flight management device of the UAV. FIG. 13 is a structural block diagram of a night flight management device according to an example embodiment of the present disclosure. As shown in FIG. 13, the night flight management device 1300 of the UAV includes a memory configured to store program instructions and a processor configured to invoke the program instructions. When being executed by the processor, the program instructions cause the processor to: obtain the night flight certificate from the terminal device and guide the night flight corresponding to the night flight application information based on the night flight certificate. After the terminal device sends the night flight application information to the night flight approval system of the flight regulatory agency, the terminal device receives the night flight certificate from the night flight approval system of the flight regulatory agency. The night flight application information is determined through detecting the night flight application operation by the user of the UAV.

In some embodiments, when guiding the night flight of the UAV corresponding to the night flight application information based on the night flight certificate, the processor is further configured to, based on the night flight certificate, remove the night flight restriction corresponding to the night flight application information.

In some embodiments, the night flight certificate includes night flight restriction information, and when guiding the night flight of the UAV corresponding to the night flight application information based on the night flight certificate, the processor is further configured to restrict the night flight of the UAV corresponding to the night flight application information according to the night flight restriction information.

In some embodiments, the night flight restriction information is determined based on the night flight application information.

In some embodiments, the night flight restriction information includes one or more of the flight altitude restriction, the flight area restriction, the flight time restriction, the flight length restriction, the flight speed restriction, and the flight route restriction of the UAV.

It can be understood that, for specific principle of the device in the embodiments of the present disclosure, reference may be made to the foregoing embodiments in FIGS. 8-10.

The present disclosure also provides a UAV including the foregoing night flight management device.

The present disclosure provides a device for determining a sunrise time and/or a sunset time. FIG. 13 is a structural block diagram of a device for determining a sunrise time and/or a sunset time according to an example embodiment of the present disclosure. As shown in FIG. 13, the night flight management device 1300 of the UAV includes a memory configured to store program instructions and a processor configured to invoke the program instructions. When being executed by the processor, the program instructions cause the processor to: obtain position information of a current area, current calendar information, and a current altitude and determine the sunrise time and/or the sunset time of the current area based on the current position information, the current calendar information, and the current altitude.

In some embodiments, when determining the sunrise time and/or the sunset time of the current area based on the current position information, the current calendar information, and the current altitude, the processor is further configured to determine a current declination of the Earth based on the calendar information, determine a solar hour angle based on the position information, determine a time correction amount based on the altitude, and determine the sunrise time and the sunset time of the current flight area of the UAV based on the current Earth declination, the solar hour angle, and the time correction amount.

In some embodiments, when obtaining the current calendar information of the current area, the processor is further configured to obtain the current calendar information of the current area through the satellite positioning receiving device.

In some embodiments, when obtaining the current calendar information of the current area, the processor is further configured to obtain the current calendar information of the current area through the mobile communication network.

It can be understood that, for specific principle of the device in the embodiments of the present disclosure, reference may be made to the foregoing embodiments in FIG. 7 and FIG. 12.

The present disclosure also provides a UAV including the foregoing device for determining the sunrise time and/or the sunset time.

The present disclosure also provides a control terminal of the UAV including the foregoing device for determining the sunrise time and/or the sunset time.

The present disclosure also provides a computer-readable storage medium. The computer-readable storage medium stores a computer program. When being executed by a processor, the computer program causes the processor implement the disclosed method.

In the embodiments of the present disclosure, the disclosed device and method may be implemented in other manners. For example, the described device embodiments are merely illustrative. For example, the division of circuits is merely a logical function division. In practical application, there may be other division manners. For example, a plurality of circuits or components may be combined or integrated into another system. Certain features may be omitted or may not be executed. Further, the displayed or discussed coupling or direct coupling or communicative connection may be through certain interfaces. The direct coupling or communicative connection between devices or circuits may be electrical, mechanical, or in other manner.

Circuits described as separate parts may be or may not be physically separate. The parts displayed as circuits may or may not be physical circuits, that is, may be located at one place or may be distributed to a plurality of network circuits. Based on actual needs, some or all circuits may be implemented to achieve the objective of the embodiments of the present disclosure.

In addition, in the embodiments of the present disclosure, various function circuits may be integrated into one processing unit or may exist physically separately. Two or more circuits may be integrated into one circuit. The integrated circuit may be implemented in hardware or may be implemented in combination of hardware and software function modules.

The integrated circuit implemented in software function modules may be stored in a computer-readable storage medium. The software function modules may be stored in the storage medium including a plurality of instructions to cause a computer device (may be a personal computer, a server, or a network device, etc.) or a processor to perform various steps of the method in the embodiments of the present disclosure. The foregoing storage medium includes various storage media for storing program codes, such as a USB disk, a portable hard disk, a read-only memory (ROM), a random-access memory (RAM), a magnetic disk or an optical disk.

Those skilled in the art could clearly understand that for the convenience and brevity of the description, the foregoing division of the function modules is intended to be illustrative. In practical applications, the foregoing functions may be allocated to different function modules according to actual needs. That is, the internal structure of the device may be divided into different function modules to perform all or some function described above. For specific operation process of the above described device, reference may be made to the corresponding process in the foregoing method embodiments, and details are not described herein again.

Various embodiments of the present disclosure are merely used to illustrate the technical solution of the present disclosure, but the scope of the present disclosure is not limited thereto. Although the present disclosure has been described in detail with reference to the foregoing embodiments, those skilled in the art should understand that the technical solution described in the foregoing embodiments can still be modified or some or all technical features can be equivalently replaced. Without departing from the spirit and principles of the present disclosure, any modifications, equivalent substitutions, and improvements, etc. shall fall within the scope of the present disclosure. Thus, the scope of present disclosure should be determined by the appended claims.

What is claimed is:

1. A night flight management method for an unmanned aerial vehicle (UAV) comprising:
determining whether the UAV is in night flight or is about to enter night flight; and
performing a flight control operation in response to determining that the UAV is in night flight or is about to enter night flight.

2. The method of claim 1, wherein determining whether the UAV is in night flight or is about to enter night flight includes:
obtaining a light intensity of a current flight area of the UAV; and
determining, based on the light intensity, whether the UAV is in night flight or is about to enter night flight.

3. The method of claim 1, wherein determining whether the UAV is in night flight or is about to enter night flight includes:
obtaining a current flight time of the UAV; and
determining, based on the flight time, whether the UAV is in night flight or is about to enter night flight.

4. The method of claim 3, wherein obtaining the current flight time of the UAV includes obtaining the current flight time through a satellite positioning receiving device.

5. The method of claim 3, wherein obtaining the current flight time of the UAV includes obtaining the current flight time through a mobile communication network.

6. The method of claim 3, wherein determining whether the UAV is in night flight or is about to enter night flight based on the current flight time of the UAV includes:
determining a night time range of a current flight area of the UAV; and
determining, based on the current flight time and the night time range, whether the UAV is in night flight or is about to enter night flight.

7. The method of claim 6, wherein determining the night time range of the current flight area of the UAV includes:
determining a sunrise time and a sunset time of the current flight area of the UAV; and
determining, based on the sunrise time and the sunset time, the night time range of the current flight area of the UAV.

8. The method of claim 7, wherein determining the sunrise time and the sunset time of the current flight area of the UAV includes:
obtaining position information, an altitude, and calendar information of the current flight area of the UAV; and
determining, based on the position information, the altitude, and the calendar information, the sunrise time and the sunset time of the current flight area of the UAV.

9. The method of claim 1, wherein performing the flight control operation includes displaying an alarm message on an interaction interface of a control terminal of the UAV.

10. The method of claim 9, wherein displaying the alarm message on the interaction interface of the control terminal of the UAV includes displaying, in response to determining that the UAV is in night flight, the alarm message on the interaction interface of the control terminal of the UAV to prompt a user that the UAV is in night flight.

11. The method of claim 9, wherein displaying the alarm message on the interaction interface of the control terminal of the UAV includes displaying, in response to determining that the UAV is about to enter the night flight, the alarm message on the interaction interface of the control terminal of the UAV to prompt a user that the UAV is about to enter the night flight.

12. The method of claim 1, wherein performing the flight control operation includes sending an alarm message to a control terminal of the UAV.

13. The method of claim 1, wherein performing the flight control operation includes restricting one or more of a flight altitude, a flight distance, a flight area range, a flight length, and a flight speed of the UAV.

14. The method of claim 1 further comprising:
determining whether the UAV has a night-flight permission; and
performing the flight control operation in response to determining that the UAV is in night flight or is about to enter night flight includes performing the flight control operation in response to determining that the UAV is in night flight or is about to enter night flight and the UAV does not have the night-flight permission.

15. The method of claim 14, wherein determining whether the UAV has the night-flight permission includes determining whether the UAV has the night-flight permission approved by a flight regulatory agency.

16. The method of claim 14, wherein determining whether the UAV has the night-flight permission includes:
determining whether the UAV has a night flight certificate issued by a night flight approval system of a flight regulatory agency; and
determining, in response to the UAV having the night flight certificate, that the UAV has the night-flight permission approved by the flight regulatory agency.

17. The method of claim 14, wherein determining whether the UAV has the night-flight permission includes:
obtaining a model of the UAV; and
determining, based on the model, whether the UAV has the night-flight permission.

18. The method of claim 14, wherein determining whether the UAV has the night-flight permission includes:
obtaining user information of the UAV; and
determining, based on the user information, whether the UAV has the night-flight permission.

19. The method of claim 14, wherein determining whether the UAV has the night-flight permission includes:
obtaining position information of a current flight area of the UAV; and
determining, based on the position information, whether the UAV has the night-flight permission.

20. A night flight management device for an unmanned aerial vehicle (UAV) comprising:
a memory storing program instructions; and
a processor configured to invoke the program instructions to:
determine whether the UAV is in night flight or is about to enter night flight; and
perform a flight control operation in response to determining that the UAV is in night flight or is about to enter night flight.
